(19) United States
(12) Patent Application Publication
(10) Pub. No.: US 2007/0098195 A1
(43) Pub. Date: May 3, 2007

(54) Wireless hearing aid system and method

(76) Inventor: David William Holmes, Colleyville, TX (US)

Correspondence Address: KEVIN MARK KLUGHART, 2516 LILLIAN MILLER PARKWAY, SUITE 115, DENTON, TX, 76210-7205, US

(21) Appl. No.: 11/491,386

(22) Filed: Jul. 22, 2006

Related U.S. Application Data
(60) Provisional application No. 60/731,965, filed on Oct. 31, 2005.

(51) Int. Cl. H04R 25/00

(52) U.S. Cl. 381/315; 381/312

(57) ABSTRACT

A wireless hearing aid system and method is disclosed that incorporates a traditional wireless transceiver headset and additional directional microphones to permit extension of the headset as a hearing aid. The disclosed invention also incorporates a mode selector and programmable audio filter to permit the headset to be wirelessly programmed with a variety of hearing aid profiles that may be downloaded via the Internet or tailored to the hearing impairment of the patient. The present invention also anticipates incorporation of circuitry within the headset to facilitate remote generation of hearing aid profiles to suit a variety of patient and/or environmental requirements.

### CROSS REFERENCE TO RELATED APPLICATIONS

Applicant claims benefit pursuant to 35 U.S.C. § 119 and hereby incorporates by reference Provisional Patent Application for “WIRELESS HEARING AID SYSTEM AND METHOD”, Ser. No. 60/731,965, docket DWH-2005-005, filed Oct. 31, 2005, and submitted to the USPTO with Express Mail on Oct. 31, 2005 with tracking number ER618466681US.

Applicant claims benefit pursuant to 35 U.S.C. § 120 and hereby incorporates by reference Utility Patent Application for “HEARING AID EARTIP”, Ser. No. 11/231,574, docket DWH-2005-004, filed Sep. 20, 2005, and submitted to the USPTO with Express Mail on Sep. 20, 2005 with tracking number ER618465791US.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention is related to over-the-ear (also referred to as behind-the-ear) hearing aids, and specifically systems and methodologies that may be used to extend the functionality and performance of these traditional hearing aid systems using wireless communications.

### PRIOR ART AND BACKGROUND OF THE INVENTION

### Prior Art Context (0100)

The prior art context in which the present invention may be generally applied is illustrated in FIG. 1 (0100) (as disclosed in U.S. Design Patent 506,258), wherein a hearing aid eartip (0101) connects to a sound tube (0102) which transmits amplified sound from an over-the-ear hearing aid (0103). These configurations may optionally include a retaining clip (0104) to aid in retaining the position of the hearing aid eartip in the ear canal.

The present invention is directed towards extending the performance and functionality of this system context. Traditionally, these hearing aid systems have been single purpose systems supporting hearing aid functionality only. The present invention extends this functionality using wireless communications and provides for additional features not present in the prior art.

### Wireless Overview (0200)

The prior art with respect to the wireless aspects of the present invention is generally illustrated in FIG. 2 (0200), which details several conventional BLUETOOTH® wireless transceivers (0201, 0202). While the physical form of the prior art may take several forms, the functionality generally includes a wireless transceiver having earpiece audio transducer (0211) and sound pickup microphone (0212). These systems generally incorporate cellular telephone, walkie-talkie, or MP3 sound/music playback functionality such as found in IPOD® brand music players.

### Problems Associated with the Prior Art

The prior art suffers from several drawbacks, including but not limited to the following:
Traditional behind-the-ear hearing aids must be configured with a hearing aid profile to compensate for the hearing impairment of the patient. This process must generally take place within the office of an audiologist, and is somewhat inconvenient for the patient. The patient generally has no method of changing hearing aid profiles in the field or selecting from alternate hearing aid profiles once the hearing aid is programmed by the audiologist.
Traditional BLUETOOTH® wireless transceivers are limited to use with cellular phone technologies and do not incorporate any hearing aid functionality.
Traditional hearing aids do not provide for any methodology of reloading the hearing aid profile by the patient, and any such reprogramming of the characteristics of the hearing aid is generally accomplished using wire connections to the hearing aid.
Traditional hearing aid profiles are generated via use of specialized equipment (external to the hearing aid itself) which maps the frequency response of the hearing impaired individual, and compensates for the degraded hearing performance of the patient. This requires that an audiologist and expensive equipment be utilized to generate a particular hearing aid profile for a patient.
Traditional hearing aids have problems interfacing with external electronics such as cellular phones, AM/FM/TV radios, MP3 players and the like.
Traditional hearing aids suffer from significant feedback problems associated with the proximity of the hearing aid microphone to the hearing aid sound transducer.
Traditional hearing aids suffer from poor signal-to-noise ratios associated with reduced gain required to minimize system feedback.
Traditional hearing aids perform poorly in crowded rooms with significant background noise due to poor signal-to-noise ratios and poor directional proximity of the hearing aid microphone to the audio source.

One significant problem associated with the prior art is the use of convex eartip assemblies. These assemblies tend to allow reflected sound from the tympanic membrane to exit the ear canal around the eartip assembly. This reflected sound may in many circumstances cause unwanted feedback with over-the-ear hearing aids.

### OBJECTIVES OF THE INVENTION

Accordingly, the objectives of the present invention are (among others) to circumvent the deficiencies in the prior art and affect the following objectives:
(1) To provide a wireless hearing aid that can incorporate concave eartip structures to minimize unwanted sound feedback and permit increased overall system sound amplification gains.
(2) To provide a wireless hearing aid that can be programmed with a hearing aid profile using wireless communications.
(3) To permit a wireless hearing aid that can be used to generate a hearing aid profile without the use of external equipment.
(4) To permit a wireless hearing aid that can be used to generate a hearing impairment profile that can be communicated wirelessly to an audiologist via computer or over the Internet.
(5) To permit a wireless hearing aid that can select from a number of standardized hearing aid profiles, loading these profiles wirelessly from a computer or over the Internet.
(6) To permit a wireless hearing aid that can select from a number of hearing aid profiles based on ambient audio conditions.
(7) To permit a wireless hearing aid that can automatically and rapidly generate an analysis of the hearing loss of a user without the need for a visit to an audiologist's office.
(8) To permit a wireless hearing aid that can be rapidly configured to the particular hearing loss of an individual user.
(9) To permit a wireless hearing aid that can be configured to the hearing loss of a user without the need for professional audiologist intervention.
(10) To permit a wireless hearing aid that can easily interface with other audio electronics such as cellular phones, AM/FM/TV radios, MP3 players, and remote audio monitor microphones.
(11) To permit a wireless hearing aid that can mimic the form factor of a traditional BLUETOOTH® transceiver and thus provide a more stylish aesthetic appearance for the hearing aid functionality.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

### Basic Wireless Hearing Aid (0300)

The present invention system context is generally illustrated in FIG. 3 (0300) wherein the user (0310) wears an embodiment of the present invention hearing aid headset body (0301) further comprising an audio output assembly (0302), directional audio input assembly (0303), and speech audio input assembly (0304).

The exemplary system as illustrated in FIG. 3 is generally designed to permit the directional audio input assembly (0303) to provide audio input directed from a particular direction, as from a person speaking to the user within the context of a proximally close conversation. The system as illustrated permits the audio output assembly (0302) to accept audio input from either the directional audio input assembly (0303), or alternative sources, such as cell phone transceivers, MP3 players, and other audio sources.

The audio output assembly (0302) may incorporate a calibration microphone in this and other contexts to permit predetermined sound frequencies to be transmitted to the user's ear canal via an audio output transducer and then measured with the calibration microphone as they bounce back from the tempanic membrane. This configuration permits some embodiments of the present invention to calibrate the hearing loss of the particular user in the field, as well as transmit this information back to an audiologist over the Internet. This hearing loss profile information can then be used either by the audiologist (or an automated computer system program) to select from among a variety of pre-determined hearing compensation profiles for the user, or in some cases provide a hearing aid profile which is tailored to the specific hearing loss of the individual user.

### Wireless Pendant Embodiment (0400)

The present invention may also be embodied in the form illustrated in FIG. 4 (0400), wherein wireless communication (0410) is utilized between a speaker (0411) and the hearing impaired user (0412) to transmit speech conversations from the speaker (0411) to the user (0412) via the use of a variety of pen (0401) and/or pendant (0402) remote audio monitor wireless transmitters to the wireless hearing aid headset (0301).

This configuration is extremely useful in crowded rooms, parties, and the like where the level of ambient noise is high and conventional hearing aids lack the ability to differentiate between background noise and the speech of the speaker (0411). In some of these scenarios the couple illustrated in FIG. 4 (0400) might be husband and wife, where the system as illustrated permits their communication even in noisy environments despite the hearing loss of the user (0412). In other circumstances, the pen/pendant (0401, 0402) remote audio monitor could be given to the speaker (0411) by the hearing impaired user (0412) if the ambient noise did not permit successful use of the directional microphone within the headset.

Note that the present invention anticipates that the user (0412) would be able to switch from the directional microphone to one or more remote pen/pendants at will, as well as configure the headset to automatically switch from the directional microphone to the remote wireless pen/pendant(s) should sufficient sound volume be detected on any of these remote units.

### BRIEF DESCRIPTION OF THE DRAWINGS

For a fuller understanding of the advantages provided by the invention, reference should be made to the following detailed description together with the accompanying drawings wherein:

FIG. 1 illustrates a prior art embodiment of a hearing aid system and associated eartip assembly (as disclosed in U.S. Design Patent 506,258);

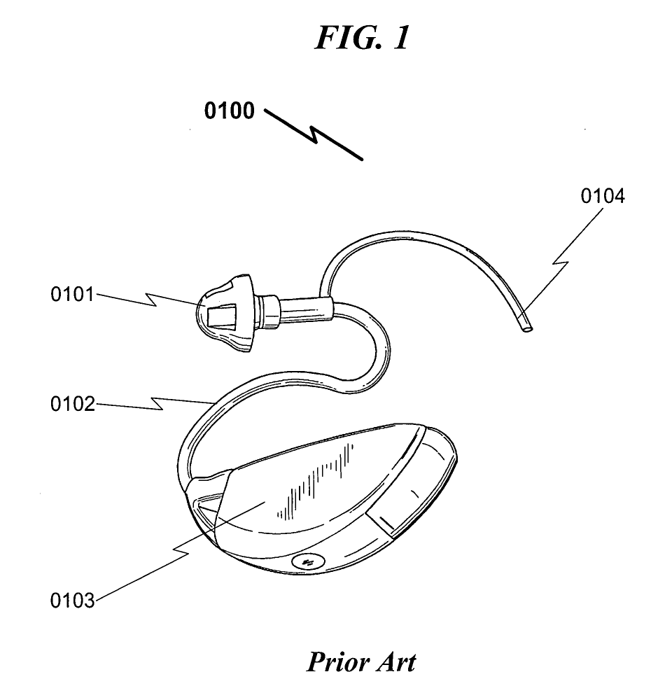

FIG. 2 illustrates two typical prior art BLUETOOTH® wireless transceiver headsets;

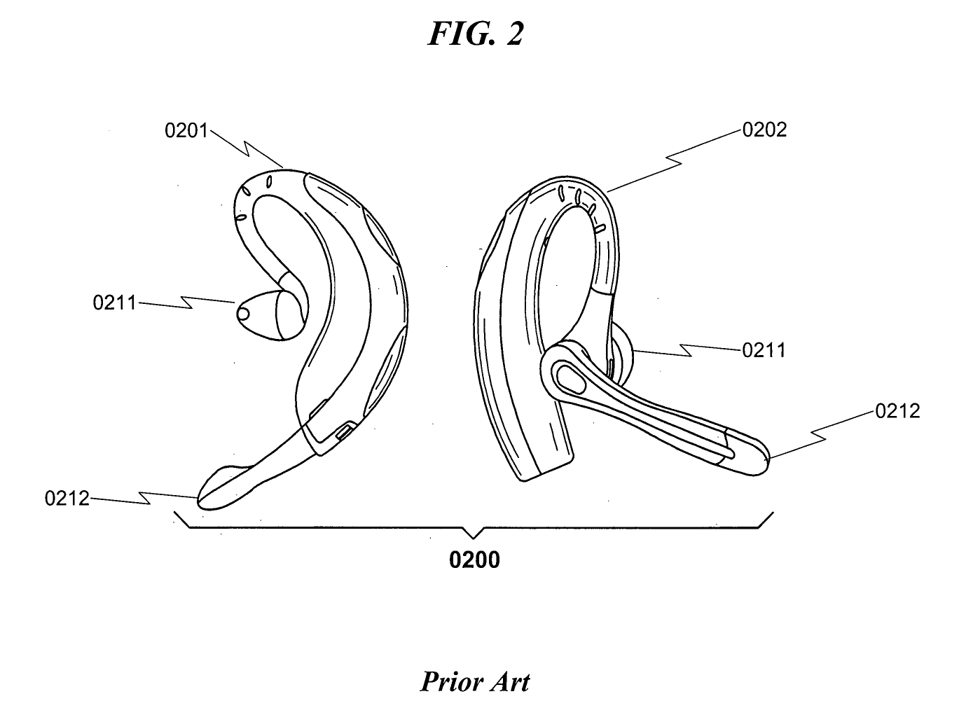

FIG. 3 illustrates a preferred exemplary embodiment of the present invention incorporating a headset and directional microphones;

FIG. 4 illustrates a preferred exemplary system context for the present invention detailing communication between the wireless hearing aid and one or more remote wireless microphones;

FIG. 5 illustrates a preferred exemplary system context for the present invention detailing the mechanism in which hearing aid profiles may be downloaded from the Internet and wirelessly loaded by the wireless hearing aid;

FIG. 6 illustrates a preferred exemplary system context for the present invention detailing the mechanism in which the wireless hearing aid may select among a variety of input sources and operating modes;

FIG. 7 illustrates a preferred exemplary method generally detailed via flowchart and useful in some embodiments of the present invention as applied to customization of hearing aid profiles;

FIG. 8 illustrates a preferred exemplary method generally detailed via flowchart and useful in some embodiments of the present invention as applied to selection of operating modes and input sources for the wireless hearing aid;

FIG. 9 illustrates a preferred exemplary method generally detailed via flowchart and useful in some embodiments of the present invention as applied to selection of hearing aid operating modes and input sources for the wireless hearing aid;

FIG. 10 illustrates an exemplary implementation of a concave eartip assembly useful in some preferred embodiments of the present invention.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a WIRELESS HEARING AID SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

Exemplary System—Multifunction Wireless Hearing Aid (0300)

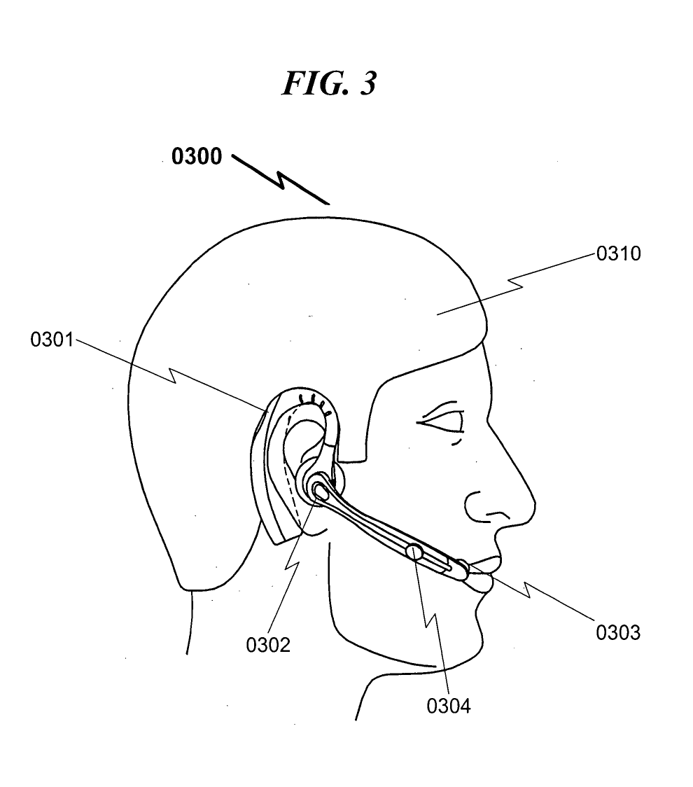

As generally illustrated in FIG. 3 (0300), a presently preferred exemplary system embodiment incorporates a headset body (0301) further comprising an audio output assembly (0302), speech audio input assembly (0303), and directional audio input assembly (0304).

In this configuration, the headset body (0301) is configured to permit the audio output assembly (0302) to be inserted into an ear canal of the person (0310) wearing the headset body (0301), the speech audio input assembly (0303) is configured to collect audio input from the mouth of the person (0310), and the directional audio input assembly (0304) is configured to collect audio input from individuals other than the person (0310).

Generally, the headset (0301) is configured such that
the audio output assembly further comprises an earpiece and audio transducer;
the speech audio input assembly further comprises a speech microphone directed towards the mouth of the person;
the directional audio input assembly further comprises a directional microphone directed away from the mouth of the person;
the audio output assembly, the directional audio input assembly, and the speech audio input assembly form a connected arcuate structure which hangs from the ear of the person;
the headset body further comprises electronics incorporating wireless interface and programmable audio filter configured by one or more hearing aid profiles selected by a profile selector;
the electronics filters audio output to the transducer in response to input from the directional microphone and/or one or remote wireless sources or other audio sources.

### Exemplary System—Wireless Remote Audio Monitor (0400)

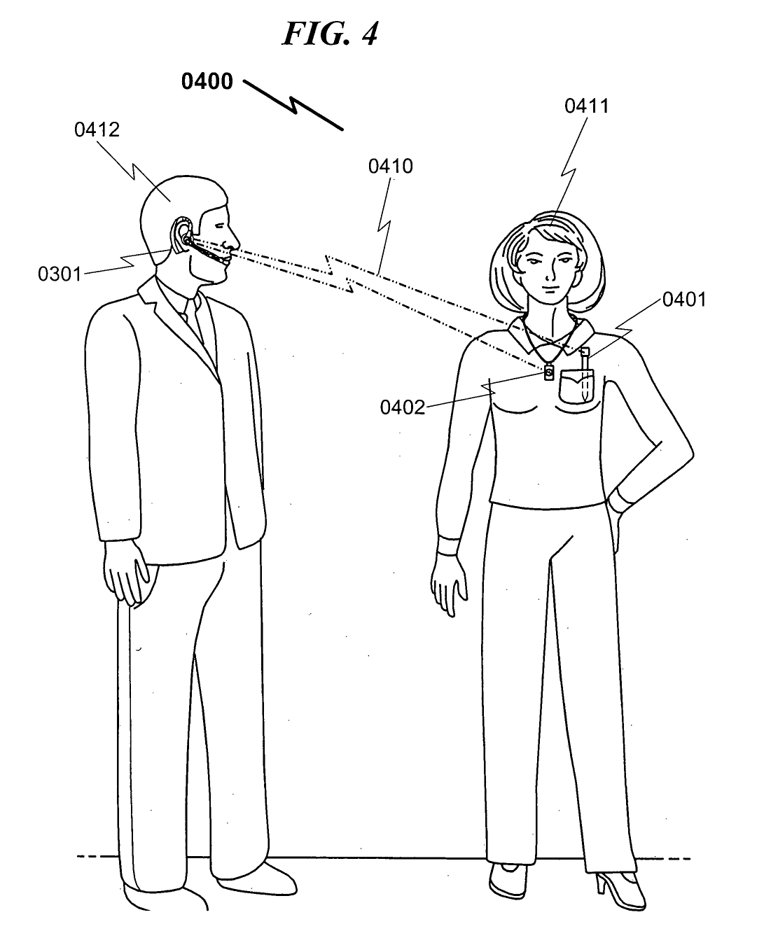

As generally illustrated in FIG. 4 (0400), a presently preferred exemplary system embodiment incorporates a wireless audio monitor which may have a variety of embodiments including pens (0401) and pendants (0402). In these configurations, a speaking person (0411) may communicate with a hearing impaired individual (0412) via wireless communication (0410) to a wireless hearing aid (0301) as described previously.

While the present invention may have a variety of configurations, the wireless audio monitor can be especially useful in noisy environments where the signal-to-noise ratio is poor due to a high degree of background noise (typically associated with parties and other social gatherings with large numbers of persons speaking). The present invention specifically anticipates electronics in the headset (0301) to automatically select between the directional microphone (0304) and the wireless audio monitor (0401, 0402) depending on the level of audio input, the ambient noise conditions, and manual selections by either the speaking person (0411) or the hearing impaired person (0412).

### Exemplary System—Wireless Hearing Aid Profile (0500)

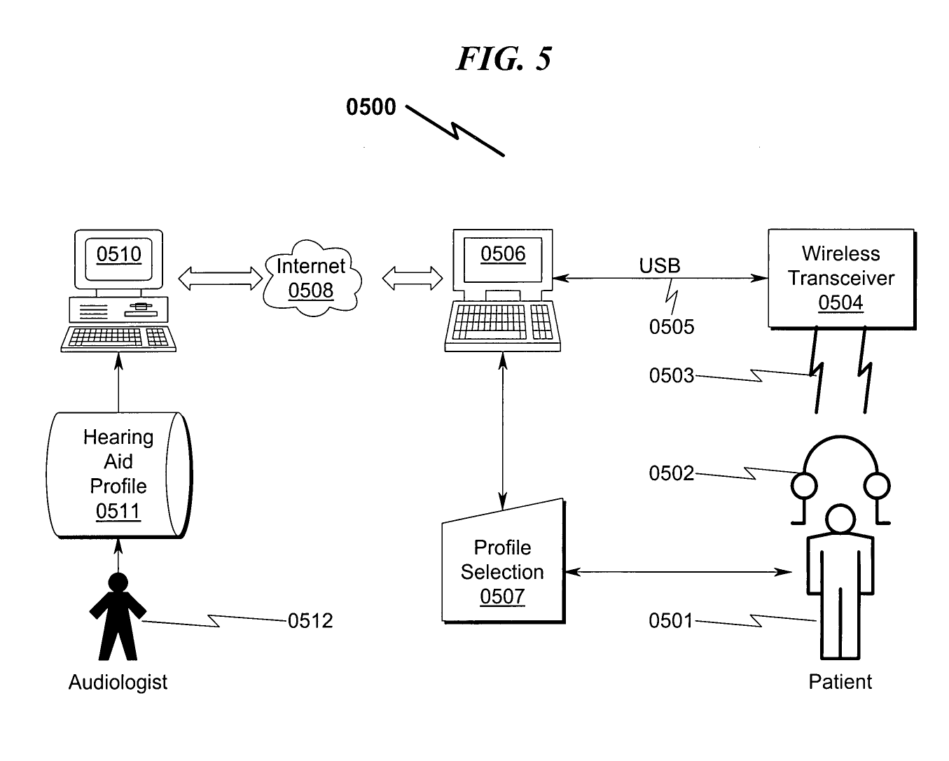

As generally illustrated in FIG. 5 (0500), a presently preferred exemplary invention system incorporates a wireless programming mode to permit downloading of hearing aid profiles (0511) to hearing aid headsets (0502) used by hearing impaired patients (0501).

The general embodiment of this programming methodology is illustrated in FIG. 5 (0500) wherein a hearing impaired patient (0501) makes use of a hearing aid headset (0502) that is configured with a wireless interface permitting wireless communication (0503) with a wireless transceiver (0504) that permits communication (0505) between the wireless headset (0502) and a computer system (0506). Note that the communication methodology (0505) utilized might be USB in some preferred embodiments, but this is not limitive to the teachings of the invention. Additionally, the present invention anticipates that the wireless transceiver (0504) may be integrated into the computer system (0506) (as in the case with many laptop computers). This computer system (0506) has incorporated software (or website web pages) that permit selection of a hearing aid profile (0507). This profile selection (0507) may be advantageously augmented by Internet communication (0508) to a host computer system (0510) that incorporates a variety of hearing aid profiles (0511) that are created and loaded by an audiologist (0512) or other medical professional.

The advantage of this system over the prior art rests in the ability of the patient (0501) to select (0507) from a variety of hearing aid profiles (0511) that may be standardized hearing aid profiles or ones tailored by a professional audiologist (0512).

One skilled in the art will recognize that this system also permits remote diagnosis of patient (0501) hearing loss by the audiologist (0512) if the hearing aid headset (0502) is configured with sound generating as well as sound receiving instrumentation in hearing aid earpiece (i.e., the audio output assembly (0302) may incorporate a calibration microphone). With this augmentation of the present invention, the patient's ear canal can be stimulated with a swept frequency spectrum and the feedback from this excitation measured at the hearing aid earpiece. This information can be transmitted to the audiologist (0512) via the Internet (0508) and one or more corrective hearing aid profiles can be generated and transmitted back to the patient (0501) via the Internet (0508). This configuration has the advantage of providing rapid feedback to the patient (0501) as well as permitting frequent updating of hearing aid profiles and the ability to tailor a variety of hearing aid profiles for a given patient (0501). For example, hearing aid profiles can be generated for a variety of common sound environments, with the particular profile being loaded by the patient via computer (0506) or selected via pushbutton on the hearing aid headset.

One skilled in the art will recognized that in some situations the hearing impaired user does not have immediate access to an audiologist, and in these circumstances it would be possible using the teachings of the present invention for the system to automatically generate a hearing aid profile for the user and put this profile into effect until a professional diagnosis could be made by an audiologist.

### Exemplary System—Mode Selector (0600)

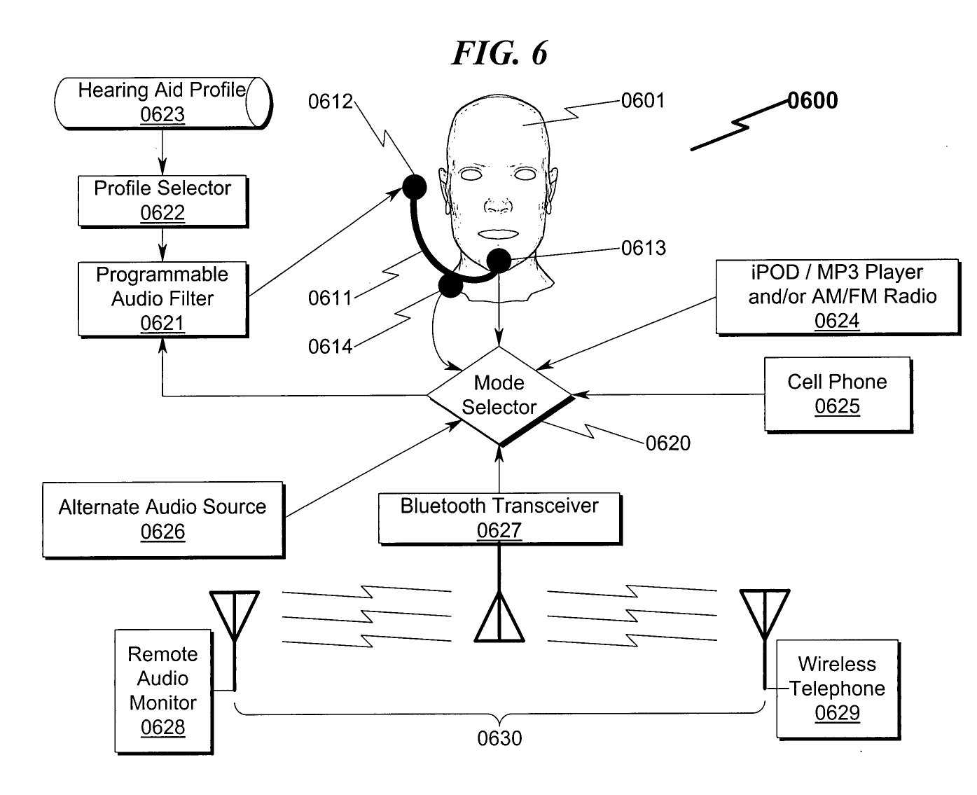

The present invention may incorporate a configuration as illustrated in FIG. 6 (0600) wherein the hearing impaired individual (0601) interacts with a mode selector element (0620) to permit a variety of audio sources to be used as input to the wireless hearing aid headset (0611). Note in this configuration the wireless hearing aid headset (0611) generally incorporates an earpiece (0612), speech microphone (0613) (used to capture audio from the hearing impaired individual (0601)), and directional microphone (0614) (used to capture audio from individuals other than the hearing impaired individual (0601)). While the earpiece (0612), speech microphone (0613) and directional microphone (0614) are illustrated schematically in FIG. 6, one skilled in the art will recognize that the wireless headset previously discussed may be applied to this embodiment in a wide variety of physical forms without departing from the spirit of the invention.

The mode selector element (0620) generally controls the source and conditioning of audio output to the earpiece (0612). The wireless hearing aid as embodied in the invention anticipates the use of a programmable audio filter (0621) which is configured by a hearing aid profile selector (0622) which in turn takes data from one or more hearing aid profiles (0623). As previously discussed, one or more of these hearing aid profiles may be determined by an audiologist and downloaded via the Internet and wirelessly loaded to the wireless hearing aid. The mode selector (0620) permits selection of a given profile in response to a variety of conditions, including user selection (via pushbutton or other input), automatic selection based on environmental conditions, and the audio source being selected for use as the output to the earpiece (0612). Thus, the mode selector (0620) and associated audio configuration system (0621, 0622, 0623) permit the earpiece (0612) to respond to a wide variety of environmental conditions and tailor these to the hearing impairment condition of the patient (0601).

FIG. 6 (0600) also illustrates a variety of exemplary audio sources which may be used in conjunction with the mode selector (0620). While this list is exemplary and can be expanded by one skilled in the art, it generally anticipates the use of MP3 music players (such as the IPOD® brand music player) and/or AM/FM/TV radios (0624), cellular and/or wireless phones (0625), alternate audio input sources (0626), as well as generic BLUETOOTH® (generically termed wireless) transceivers (0627). Use of wireless transceivers (0627) permits integration of wireless audio monitors (0628) as well as wireless telephones (0629) and the like. The system anticipates that the wireless transceiver (0627) may communicate with a variety of wireless devices via the use of antennas and traditional RF transceiver technology (0630).

### System Variations

The present invention anticipates a wide variety of variations in the basic theme of construction. The examples presented previously do not represent the entire scope of possible usages. They are meant to cite a few of the almost limitless possibilities.

Exemplary Method—Hearing Aid Profile Selector (0700)

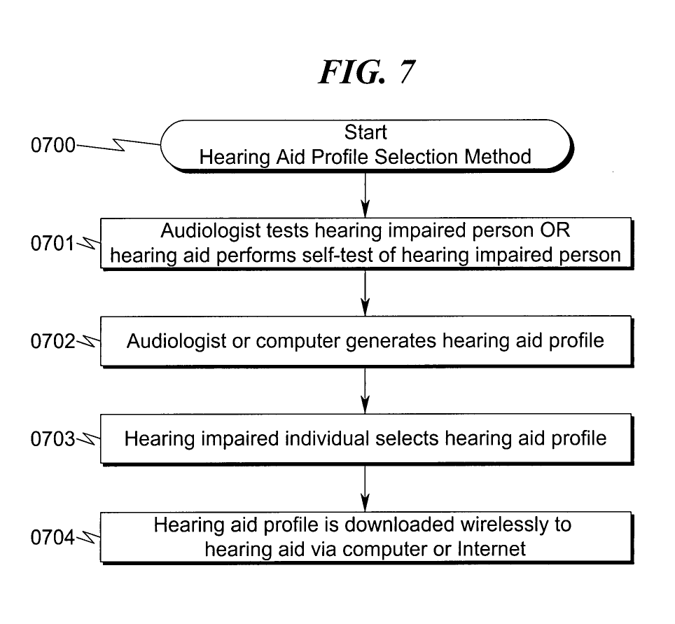

The present invention may incorporate a method as illustrated in FIG. 7 (0700) to permit a hearing impaired person to implement a variety of hearing aid profiles via wireless means. The general steps associated with this method generally involve the following:
Audiologist tests hearing impaired person OR hearing aid performs self-test of hearing impaired person (0701);
Audiologist or computer generates hearing aid profile (0702);
Hearing impaired individual selects hearing aid profile (0703);
Hearing aid profile is downloaded wirelessly to hearing aid via computer or Internet (0704).
   One skilled in the art will recognize that these steps may be rearranged without detracting from the teachings of the present invention.

Exemplary Method—Hearing Aid Audio Selector (0800)

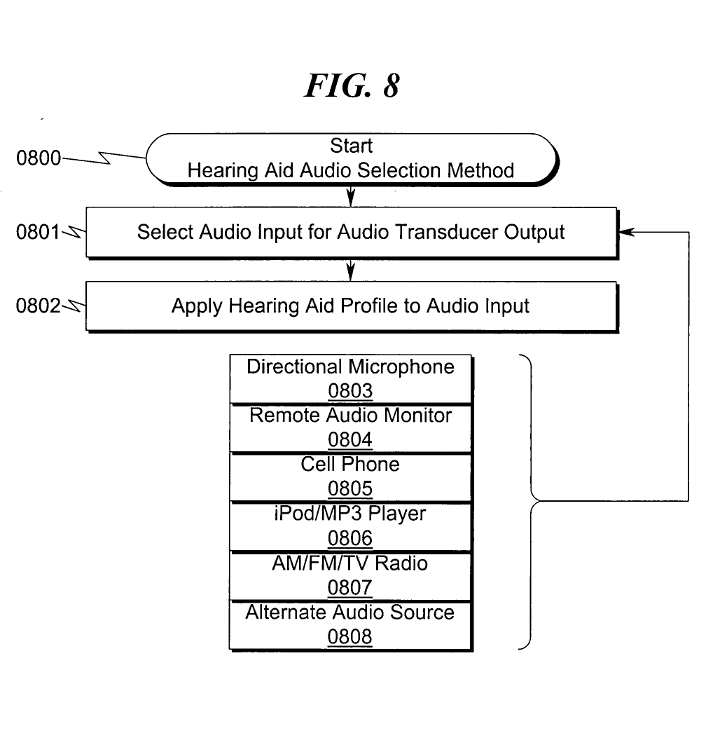

The present invention may incorporate a method as illustrated in FIG. 8 (0800) to permit a hearing impaired person to select from a variety of audio input sources via wireless means. The general steps associated with this method generally involve the following:
Select Audio Input for Audio Transducer Output (0801) from a variety of sources, including but not limited to directional microphones (0803), wireless remote audio monitors (0804), cell phones (0805), IPOD®/MP3 players (0806), AM/FM/TV radios (0807), and alternate audio sources (0808);
Apply Hearing Aid Profile to Audio Input (0802) and transmit this modified audio to the hearing aid audio transducer.
   One skilled in the art will recognize that these steps may be rearranged or modified without detracting from the teachings of the present invention.

### Exemplary Method—Hearing Aid Mode Selection (0900)

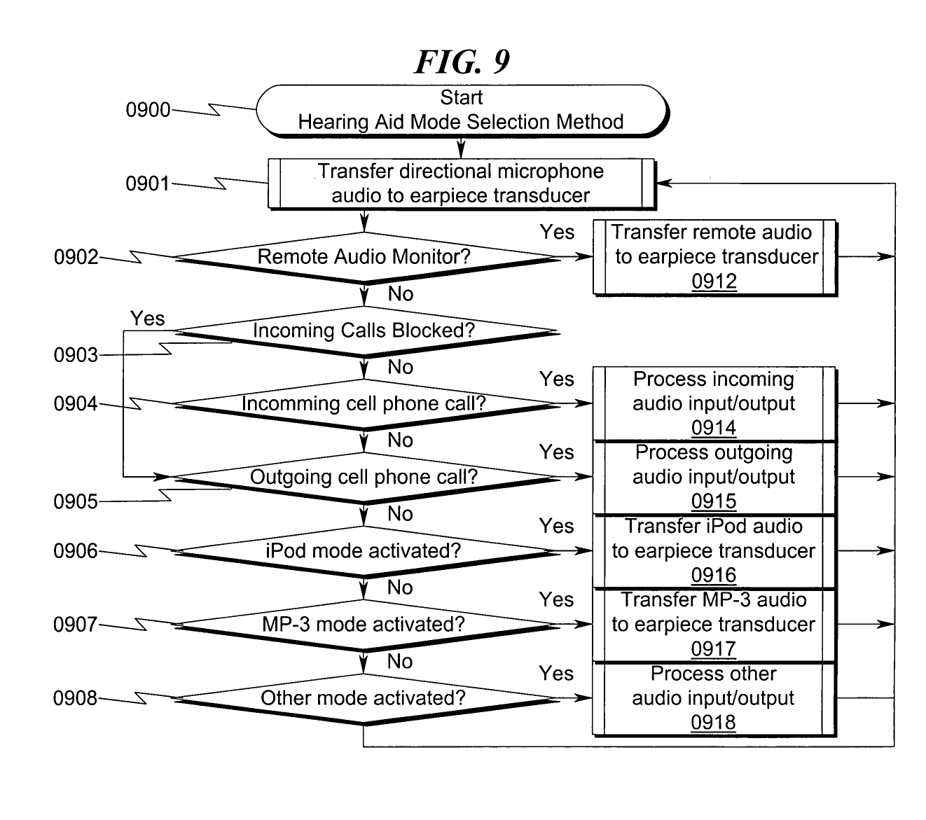

The present invention may incorporate a method as illustrated in FIG. 9 (0900) to permit a wireless hearing aid to select from among a number of audio inputs and/or outputs to determine its mode of operation. The general operation of this method is as follows:
1. Primary mode is always on as a “Hearing Aid” device.
2. Primary mode as a “Hearing Aid” can be over-ridden when:
   a. An incoming cellular phone call is answered.
   b. During an outgoing cellular phone call.
   c. When in “IPOD®” mode.
   d. When in “MP-3” mode.
   e. When in any other alternate mode is selected.
3. Incoming cellular phone calls can be blocked when a “Remote Audio Monitor” is selected.
4. Incoming cellular phone calls can be either “blocked” or “unblocked”.
   While implementation of this method may take a variety of forms, the general method as illustrated by the flowchart of FIG. 9 (0900) can serve as an exemplary embodiment of this method. This method may be generally described by the following steps:
1. The primary mode is activated by first transferring directional microphone audio input to the earpiece transducer (0901);
2. If the remote audio monitor is activated (0902), then audio is transferred from the remote audio monitor to the earpiece transducer (0912) and control returns to step 1 when this process is completed or a state change is detected;
3. If incoming calls are blocked (0903), then control is passed to step 5 (0905), otherwise control is passed to step 4 (0904);
4. If an incoming cell phone call is detected (0904), then audio input/output is processed for the call (0914) and control returns to step 1 when this cell phone process is completed or a state change is detected;
5. If the outgoing cell phone call is activated (0905), then audio input/output is processed for the call (0915) and control returns to step 1 when this cell phone process is completed or a state change is detected;
6. If the IPOD® mode is activated (0906), then audio input is processed for the IPOD® (0916) and control returns to step 1 when this process is completed or a state change is detected;
7. If the MP-3 mode is activated (0907), then audio input is processed for the MP-3 player (0917) and control returns to step 1 when this process is completed or a state change is detected;
8. If the some other audio input/output device is activated (0908), then audio input is processed for this auxiliary I/O device (0918) and control returns to step 1 when this process is completed or a state change is detected;
9. Otherwise, control returns to step 1.
   One skilled in the art will recognize that these steps may be rearranged or modified without detracting from the teachings of the present invention.

### Concave Eartip (1000)

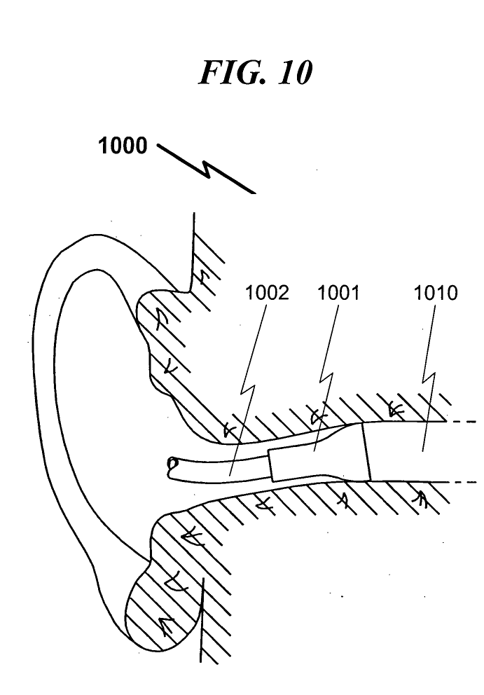

The present invention may incorporate a concave eartip as illustrated in FIG. 10 (1000) wherein the eartip (1001) is connected to the audio output assembly (0302) via a tube structure (1002), with the resulting eartip/tube structure residing in the user's ear canal (1010).

The advantage of this concave structure is that it tends to minimize feedback between the audio output assembly sound generator and the external microphone assemblies (0303, 0304) by trapping sound that is reflected back from the tempanic membrane, thus permitting the system to operate at higher gains without the potential for annoying feedback.

### System Summary

A preferred embodiment of the claimed system invention can be summarized as a wireless hearing aid comprising a headset body further comprising an audio output assembly, speech audio input assembly, and directional audio input assembly wherein
the headset body is configured to permit the audio output assembly to be inserted into an ear canal of the person wearing the headset body, the speech audio input assembly to collect audio input from the mouth of the person, and the directional audio input assembly to collect audio input from individuals other than the person;
the audio output assembly further comprises an earpiece and audio transducer;
the speech audio input assembly further comprises a speech microphone directed towards the mouth of the person;
the directional audio input assembly further comprises a directional microphone directed away from the mouth of the person;
the audio output assembly, the directional audio input assembly, and the speech audio input assembly form a connected arcuate structure which hangs from the ear of the person;
the headset body further comprises electronics incorporating wireless interface and programmable audio filter configured by one or more hearing aid profiles selected by a profile selector;
the electronics filters audio output to the transducer in response to input from the directional microphone.

This basic system may be modified in a wide variety of ways, including incorporation of a variety of modifications, including but not limited to the following:
The audio output assembly further comprises a concave eartip.
The audio output assembly further comprises a calibration microphone.
The hearing aid profiles are downloaded to the hearing aid using the wireless interface via communication with a local computer configured with a wireless interface.
The hearing aid profiles are downloaded to the hearing aid using the wireless interface via the Internet.
The hearing aid profiles are determined by an audiologist and downloaded to the hearing aid using the wireless interface via the Internet.
The hearing aid profiles are selected from a predetermined list of standardized hearing aid profiles and downloaded to the hearing aid using the wireless interface via the Internet.
The electronics further comprises a mode selector.
The electronics further comprises a mode selector which directs audio signals from the directional microphone or an audio source input to the programmable filter.
The electronics further comprises a mode selector which directs audio signals from the directional microphone or an AM/FM radio input to the programmable filter.
The electronics further comprises a mode selector which directs audio signals from the directional microphone or an IPOD® player input to the programmable filter.
The electronics further comprises a mode selector which directs audio signals from the directional microphone or a MP3 player input to the programmable filter.
The electronics further comprises a mode selector which directs audio signals from the directional microphone or a cellular telephone input to the programmable filter.
The electronics further comprises a mode selector which directs audio signals from the directional microphone or a wireless remote audio monitor to the programmable filter.
The electronics further comprises a mode selector which directs audio signals from the directional microphone or a wireless telephone audio monitor to the programmable filter.
The electronics further comprises a BLUETOOTH® wireless transceiver.

One skilled in the art will recognize that this list of anticipated modifications is only exemplary, and can be expanded to include other features (such as the tinnitus treatment features discussed later in this document) not specifically detailed in this document.

### Method Summary

A preferred embodiment of the claimed method invention can be summarized as a method of operating a wireless hearing aid, the hearing aid comprising a headset body further comprising an audio output assembly, speech audio input assembly, and directional audio input assembly, the method comprising:
(1) Selecting an audio input source for audio transducer output to the audio output assembly, from a variety of sources, including but not limited to directional microphones, wireless remote audio monitors, cell phones, IPOD®/MP3 players, AM/FM/TV radios, and alternate audio sources;
(2) Applying a hearing aid profile to the audio input and transmitting this modified audio to the audio output assembly.

This basic method may be modified in a wide variety of ways, including incorporation of a variety of modifications, including but not limited to the following:
The audio input source is a directional microphone.
The audio input source is a wireless remote audio monitor.
The audio input source is a cell phone.

As indicated elsewhere, tinnitus masking may be incorporated within the hearing aid profile electronics.

### Invention Advantages Over the Prior Art

The instant invention has several advantages over the prior art, including but not limited to the following:
The device's circuit can be programmed according to the configuration of the wearer's hearing loss. This feature can utilize the unique frequency response generated according the wearer's individual hearing loss. This feature assists the wearer in obtaining the optimum clarity possible for all incoming signals, e.g. speech, television phone calls, music, audio books, car radios, IPOD®, and MP3 players.
By transmitting via Bluetooth® wireless there will be an enhancement in the clarity of the signal by improving the signal-to-noise ratio for every sound that is transmitted. This is particularly true for speech. The vowels in speech contain 90% of the energy and only 10% of the meaning. Consonants, on the other hand, represent only 10% of the energy in speech, but contribute 90% of the meaning. Therefore, when there is background noise the soft consonants become “buried” in the noise and speech becomes unintelligible. By increasing the amplification of the high frequencies (consonants) and reducing the background noise, the signal-to-noise ratio is improved and speech then becomes clear.
There is a law in physics that is called the “Inverse Square Law” that states: “as the distance from the signal to the receiver is doubled, the sound pressure level is reduced 6 dB SPL each time it is doubled”. When a signal is transmitted wirelessly, there is no loss in intensity due to the Inverse Square Law. An example would be:
   A person is standing three feet away and the Speakers voice is measured at 60 dB SPL. The background noise is also measured at 60 dB SPL, thus presenting a signal-to-noise ratio of 60:60 or 0 dB SPL. The Speaker now moves and is now six feet away from the listener. If everything remains the same in the environment, the signal-to-noise ratio is now 54:60 or −6 dB. The Speaker again moves and is now 12 feet away from the Speaker. The signal-to-noise ration is now 48:60 or −12 dB. Finally the Speaker moves across the room and is now 24 feet away. The signal-to-noise ratio is now 42:60 or −18 dB. Now the Speaker finds it difficult to “understand” what is being said, because the weak vowels are now so “buried” in the background noise that speech is muffled. With wireless transmission (Bluetooth®) the Speaker can now move 10 meters or approximately 30 feet away and speech remains clear, because there is no loss of transmission power and the Inverse Square Law does not come into play.
      One skilled in the art will recognize that other advantages may be present in the instant invention that are not listed above, with no loss of scope in the instant invention teachings.

### Tinnitus Masking May Be Incorporated in Hearing Aid

The present invention specifically anticipates that the hearing aid audio filter (0621), profile selector (0622), and/or hearing aid profile (0623) may incorporate tinnitus masking functions further incorporating the use of either ultrasonic background noise or modulation of ultrasonic waves by filtered audio signals for the purposes of minimizing tinnitus symptoms in patients with this condition. Thus, the present invention specifically anticipates that the scope of the “hearing aid” functions contained in this wireless hearing aid system and method extend beyond the current prior art functionality in this regard with the possible incorporation of additional treatment/filtering capabilities not present in the prior art.

### CONCLUSION

A wireless hearing aid system and method has been disclosed that incorporates a traditional wireless transceiver headset and additional directional microphones to permit extension of the headset as a hearing aid. The disclosed invention also incorporates a mode selector and programmable audio filter to permit the headset to be wirelessly programmed with a variety of hearing aid profiles that may be downloaded via the Internet or tailored to the hearing impairment of the patient. The present invention also anticipates incorporation of circuitry within the headset to facilitate remote generation of hearing aid profiles to suit a variety of patient and/or environmental requirements.

### CLAIMS

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A wireless hearing aid comprising:
(a) headset body further comprising an audio output assembly, speech audio input assembly, and directional audio input assembly;
wherein
said headset body is configured to permit said audio output assembly to be inserted into an ear canal of the person wearing said headset body, said speech audio input assembly to collect audio input from the mouth of said person, and said directional audio input assembly to collect audio input from individuals other than said person;
said audio output assembly further comprises an earpiece and audio transducer;
said speech audio input assembly further comprises a speech microphone directed towards said mouth of said person;
said directional audio input assembly further comprises a directional microphone directed away from said mouth of said person;
said audio output assembly, said directional audio input assembly, and said speech audio input assembly form a connected arcuate structure which hangs from the ear of said person;
said headset body further comprises electronics incorporating wireless interface and programmable audio filter configured by one or more hearing aid profiles selected by a profile selector;
said electronics filters audio output to said transducer in response to input from said directional microphone.

2. The wireless hearing aid of claim 1 wherein said audio output assembly further comprises a concave eartip.

3. The wireless hearing aid of claim 1 wherein said audio output assembly further comprises a calibration microphone.

4. The wireless hearing aid of claim 1 wherein said hearing aid profiles are downloaded to said hearing aid using said wireless interface via communication with a local computer configured with a wireless interface.

5. The wireless hearing aid of claim 1 wherein said hearing aid profiles are downloaded to said hearing aid using said wireless interface via the Internet.

6. The wireless hearing aid of claim 1 wherein said hearing aid profiles are determined by an audiologist and downloaded to said hearing aid using said wireless interface via the Internet.

7. The wireless hearing aid of claim 1 wherein said hearing aid profiles are selected from a predetermined list of standardized hearing aid profiles and downloaded to said hearing aid using said wireless interface via the Internet.

8. The wireless hearing aid of claim 1 wherein said electronics further comprises a mode selector.

9. The wireless hearing aid of claim 1 wherein said electronics further comprises a mode selector which directs audio signals from said directional microphone or an audio source input to said programmable filter.

10. The wireless hearing aid of claim 1 wherein said electronics further comprises a mode selector which directs audio signals from said directional microphone or an AM/FM radio input to said programmable filter.

11. The wireless hearing aid of claim 1 wherein said electronics further comprises a mode selector which directs audio signals from said directional microphone or an IPOD® player input to said programmable filter.

12. The wireless hearing aid of claim 1 wherein said electronics further comprises a mode selector which directs audio signals from said directional microphone or a MP3 player input to said programmable filter.

13. The wireless hearing aid of claim 1 wherein said electronics further comprises a mode selector which directs audio signals from said directional microphone or a cellular telephone input to said programmable filter.

14. The wireless hearing aid of claim 1 wherein said electronics further comprises a mode selector which directs audio signals from said directional microphone or a wireless remote audio monitor to said programmable filter.

15. The wireless hearing aid of claim 1 wherein said electronics further comprises a mode selector which directs audio signals from said directional microphone or a wireless telephone audio monitor to said programmable filter.

16. The wireless hearing aid of claim 1 wherein said electronics further comprises a BLUETOOTH® wireless transceiver.

17. A method of operating a wireless hearing aid, said hearing aid comprising a headset body further comprising an audio output assembly, speech audio input assembly, and directional audio input assembly, said method comprising:
(3) Selecting an audio input source for audio transducer output to said audio output assembly, from a variety of sources, including but not limited to directional microphones, wireless remote audio monitors, cell phones, IPOD®/MP3 players, AM/FM/TV radios, and alternate audio sources;
(4) Applying a hearing aid profile to said audio input and transmitting this modified audio to said audio output assembly.

18. The method of claim 17 wherein said audio input source is a directional microphone.

19. The method of claim 17 wherein said audio input source is a wireless remote audio monitor.

20. The method of claim 17 wherein said audio input source is a cell phone.
